(19) United States
(12) Patent Application Publication
(10) Pub. No.: US 2007/0142054 A1
(43) Pub. Date: Jun. 21, 2007

(54) Method and system for managing a call setup between a mobile station and a communication infrastructure

(76) Inventors: Garg Sanjeev, Arlington Heights, IL (US); Alfred R. Castillo, West Dundee, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/300,743

(22) Filed: Dec. 15, 2005

(51) Int. Cl. H04Q 7/20

(52) U.S. Cl. 455/450

(57) ABSTRACT

A method and system for managing a call setup between a mobile station (102) and a communication infrastructure (104) is provided. The method includes the detection (202) of a call setup failure by the mobile station, based on non-receipt of a next expected message sent by the communication infrastructure. The method further includes the mobile station sending a rejection order message to the communication infrastructure, to indicate at least one cause of the call setup failure. The communication infrastructure sends a re-synchronization message to the mobile station. Thereafter, the mobile station resumes the call setup, based on the received re-synchronization message.

### FIELD OF THE INVENTION

The present invention relates generally to mobile communication, and more specifically, to managing a call setup in a mobile communication system.

### BACKGROUND

Mobile communication systems provide voice and data services to users of mobile devices, and are classified based on transmission standards used in communication between mobile devices. Examples of transmission standards include, but are not limited to, Global System for Mobile Communications (GSM), Code Division Multiple Access (CDMA), Universal Mobile Telecommunications System (UMTS), Evolution Data Voice (EVDV), High-Speed Downlink Packet Access (HSDPA), Enhanced Data rates for Global Evolution (EDGE), and General Packet Radio Service (GPRS). CDMA assigns a unique code to each user accessing the frequency spectrum. Each user encodes the data to be transferred by using this unique code. Therefore, CDMA enables multiple users to access the entire frequency spectrum simultaneously.

According to a CDMA based standard such as CDMA 2000, when a mobile station (MS) sets up a call with another MS, it interacts with a communication infrastructure to obtain radio resources for a call setup. An example of a communication infrastructure includes a Radio Access Network (RAN). The radio resources can include frequency assignments, sector separation, and transmit power control. The communication infrastructure can include a Base Transceiver Station (BTS), which is the interface between the mobile devices and the communication infrastructure. The communication infrastructure and the mobile station exchange a set of messages for performing the call setup in accordance with CDMA standards. The set of messages includes messages for origination of the call setup, channel assignment messages, and acknowledgement messages. A channel assignment message assigns a traffic channel to the MS. The traffic channel is a medium for exchanging data and signaling messages between the MS and the communication infrastructure. Each of the communication infrastructure and mobile station can be considered to include a call state machine respectively indicating its call state status in call flow process. The call state status includes information such as which message from the set of messages has been recently sent or received. Hence, the proper exchange of the set of messages can be visualized as synchronization of two call state machines. If the MS is unable to receive any one message from the set of messages, the call setup fails. The failure of the call setup can be detected either by the MS or the communication infrastructure.

An attempt made by the MS to resume the call setup re-originates the call setup without user interaction. This causes unnecessary delay while repeating call setup steps that were successfully completed the first time. Due to this delay the probability of radio frequency (RF) related failures increases. The lack of a synchronization mechanism causes the communication infrastructure to ignore attempts made by the MS to resume the call setup. This results in the communication infrastructure sending unwanted messages to the MS. Due to these unwanted messages, resumption of the call setup is delayed. This, in turn results in an undue increase in the capacity consumption of communication channels.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an abstract model of a mobile communication system supporting communication between mobile stations through a communication infrastructure, in accordance with an embodiment of the invention.

FIG. 2 is an exemplary process flow diagram illustrating a method for managing a call setup between a mobile station and a communication infrastructure, in accordance with an embodiment of the invention.

FIG. 3 is an exemplary message flow diagram illustrating the messages exchanged between a mobile station and a communication infrastructure while managing a call setup, in accordance with an embodiment of the invention.

FIG. 4 is an exemplary message flow diagram illustrating the messages exchanged between a mobile station and a communication infrastructure while managing a call setup, in accordance with another embodiment of the invention.

FIG. 5 represents a block diagram of a mobile station, in accordance with an embodiment of the invention.

FIG. 6 represents a block diagram of a communication infrastructure, in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A method for managing a call setup between a mobile station and a communication infrastructure is disclosed. The method includes the detection of a call setup failure. The method further includes sending a rejection order message, which indicates one or more causes of the call setup failure. Further, the method includes re-synchronizing the call setup by responding to the rejection order message with a message.

In an embodiment of the invention, a mobile station for managing a call setup is disclosed. The mobile station includes a transceiver, which receives and transmits messages regarding setting up a communication channel. The mobile station also includes a processor that is coupled to the transceiver. The processor detects a call setup failure and instructs the transceiver to transmit a rejection order message, which indicates at least one cause of the call setup failure. The processor further receives a re-synchronization message, which is used to re-synchronize the call setup corresponding to the at least one cause of the call setup failure.

In another embodiment of the invention, a communication infrastructure for managing a call setup is disclosed. The communication infrastructure includes a base site, which is arranged to receive and transmit messages to establish a communication channel. The communication infrastructure further includes a controller that is coupled to the base site. The controller instructs the base site to send a re-synchronization message in response to a rejection order message. The rejection order message indicates at least one cause of a call setup failure. The re-synchronization message utilizes at least this one cause of the call setup failure to establish the communication channel.

Before describing in detail the embodiments in accordance with the present invention, it should be observed that the embodiments reside primarily in combinations of method steps and apparatus components related to managing a call setup between a mobile station and a communication infrastructure. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

A “set” as used in this document, means a non-empty set (i.e., comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically.

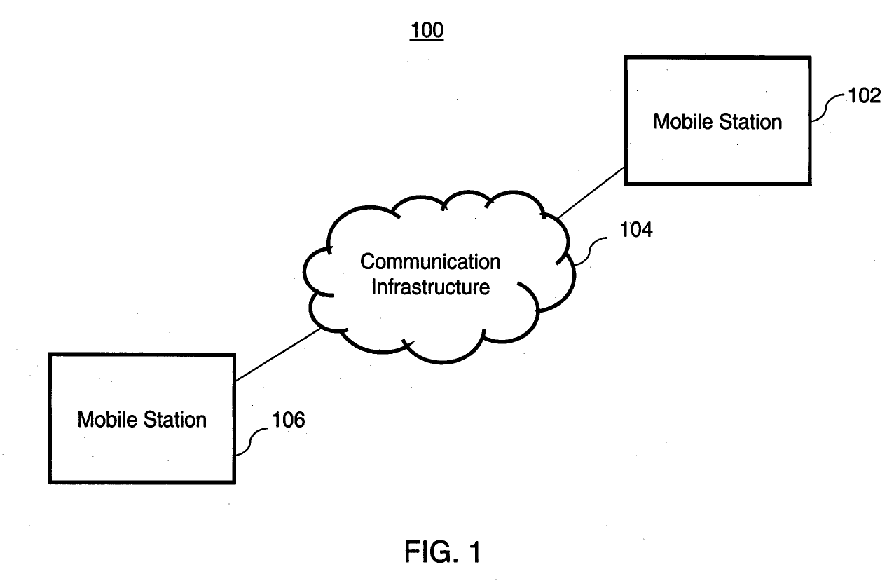

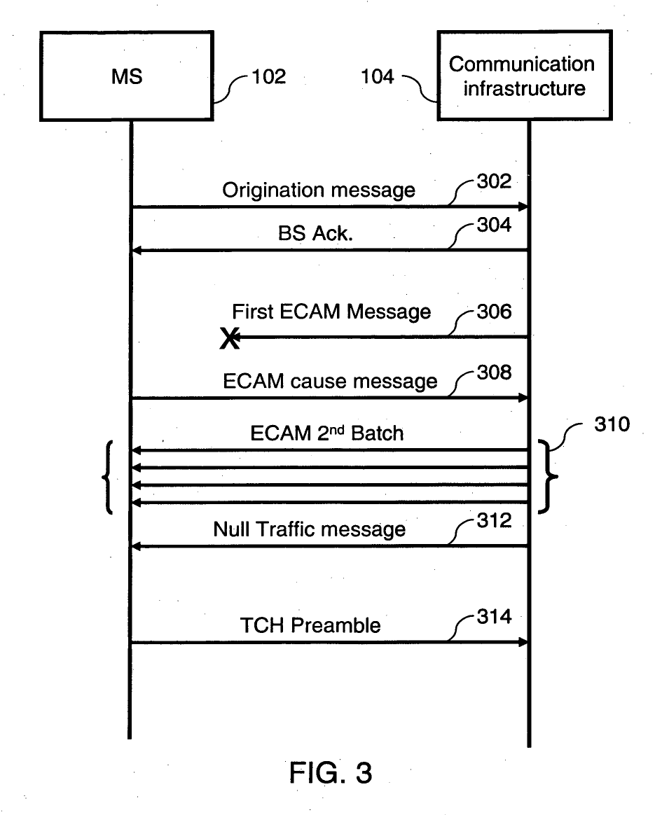

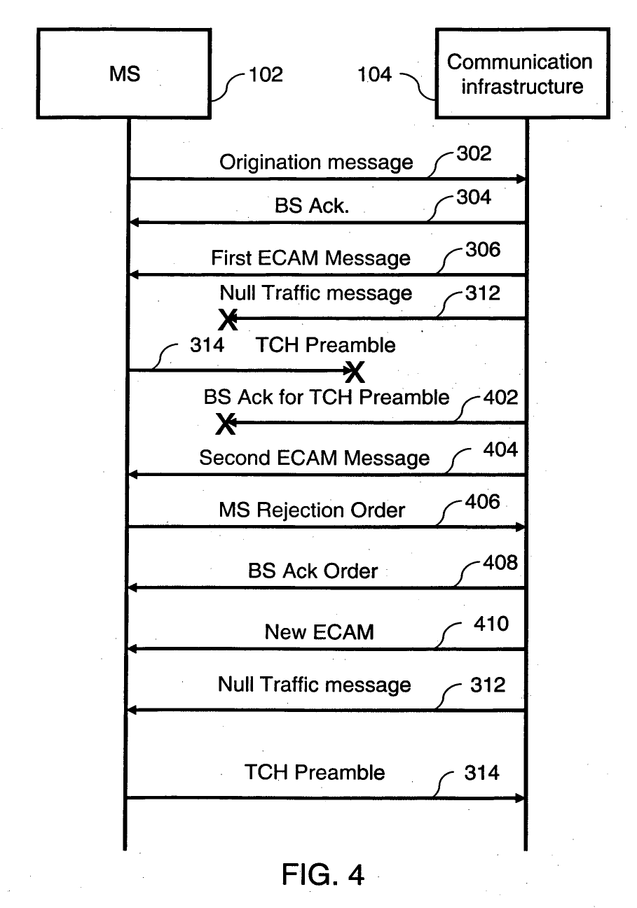

FIG. 1 is an abstract model of a communication system 100 supporting the communication between two mobile stations through a communication infrastructure 104, in accordance with an embodiment of the invention. The communication system 100 includes a mobile station (MS) 102, the communication infrastructure 104, and an MS 106. It will be apparent to a person ordinarily skilled in the art that the MS 102 and the MS 106 can be functionally and structurally the same, and are differentiated only for the sake of clarity. Further, for illustrative purposes, only two mobile stations 102 and 106 are shown in FIG. 1. However, the number of mobile stations can be varied in different embodiments of the invention. Examples of mobile stations include cellular phones, which are capable of exchanging messages with the communication infrastructure 104. In an embodiment of the invention, the communication infrastructure 104 includes a Radio Access Network (RAN), which can include a Base Transceiver Station (BTS) and a Base Station Controller (BSC). The BTS acts as an interface between the RAN and the MS 102 or the MS 106. The BSC is responsible for assigning channels to the MS 102 via the BTS. The MS 102 exchanges messages with the communication infrastructure 104 in order to set up a call with the MS 106. In accordance with various embodiments of the invention, the messages exchanged between the MS 102 and the communication infrastructures 104 are described in conjunction with FIG. 3. and FIG. 4.

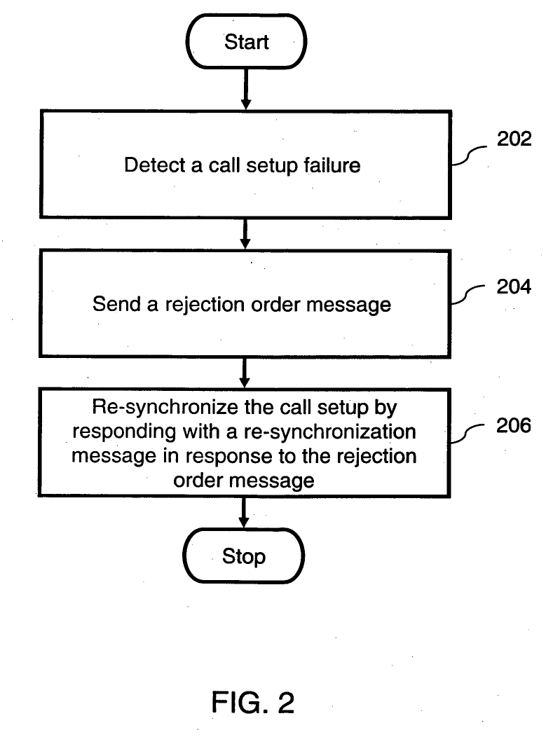

FIG. 2 is an exemplary process flow diagram illustrating a method for managing a call setup between the MS 102 and the communication infrastructure 104, in accordance with an embodiment of the invention. At step 202, a call setup failure is detected. In an embodiment of the invention, the MS 102 detects the call setup failure. The call setup failure can be detected, based on the MS 102 not receiving a next expected message after receiving an acknowledgement message from the communication infrastructure 104. An acknowledgement message is a response sent by either an MS or a communication infrastructure to confirm receipt of a signaling message. An example of the acknowledgement message includes, but is not limited to, a Base Station (BS) acknowledgement message sent by the communication infrastructure 104 either as an acknowledgment of an origination message sent by the MS 102, or as an acknowledgment of a traffic channel preamble (TCH) message sent by the MS 102. In an embodiment of the invention, a BTS in the communication infrastructure 104 sends the BS acknowledgement message. Examples of the next expected message include, but are not limited to, a channel assignment message, a null traffic message, and the acknowledgement message. A channel assignment message assigns a traffic channel to the MS 102 to exchange user and signaling messages. A null traffic message is a sequence of one or more frames of a pre-defined specific data sequence sent between the MS 102 and the communication infrastructure 104. The null traffic message is sent when no data pertaining to the call is being exchanged between the MS 102 and the communication infrastructure 104, and when connectivity needs to be maintained between them. In other words, the null traffic message is sent when both the MS 102 and communication infrastructure 104 are in idle state.

At step 204, a rejection order message is sent. In an embodiment of the invention, the MS 102 sends the rejection order message to the communication infrastructure 104. The MS 102 determines at least one cause of the call setup failure corresponding to the non-receipt of the next expected message from the rejection order message. The causes of the call setup failure include, but are not limited to, a high paging channel erasure rate, the number of overhead messages lost, a high symbol error rate over an overhead or paging channel, low energy over the overhead or paging channel, a high number of idle handoffs, a last good call state of the MS 102, a next expected message, and a high number of idle handoffs over a time interval. In an example, a high paging channel erasure rate indicates a high ratio of number of erased frames to the number of total frames received by the MS 102 from the communication infrastructure 104. In an example, the number of overhead message lost indicates the number of specific messages sent by the communication infrastructure 104 which are not received by the MS 102. These specific messages are used to communicate base station-specific data by the communication infrastructure 104 to the MS 102. In an example, a high symbol error rate means a high ratio of number of erased symbols to the number of total symbols received by the MS 102. In an example, a high number of idle handoffs indicate that the MS 102 has a high number of handoffs when it is in idle state. An idle handoff occurs when the MS 102, in idle state, finds a strong signal from a neighboring BTS and switches over its communication from the present BTS to the neighboring BTS. The last good call state is a state of the call state machine (of the MS 102) from whereon it is capable to resume the call setup. The rejection order message is explained in detail in conjunction with FIG. 3 and FIG. 4.

At step 206, the call setup is re-synchronized by responding with a re-synchronization message in response to the rejection order message. In an embodiment of the invention, the communication infrastructure 104 re-synchronizes the call setup by sending the re-synchronization message to the MS 102, based on the rejection order message received. Examples of the re-synchronization message include, but are not limited to, at least one message from a set of channel assignment messages and an acknowledgement order message. An example of a channel assignment message includes, but is not limited to, an Extended Channel Assignment Message (ECAM) message. An example of an acknowledgement order message includes, but is not limited to, a BS acknowledgement order message. In an embodiment of the invention, the communication infrastructure 104 sends the set of channel assignment messages as the re-synchronization message to the MS 102, in case the MS 102 specifies in the rejection order message, the non-receipt of a channel assignment message in response to receiving a BS acknowledgement message. In another embodiment of the invention, the communication infrastructure 104 sends the acknowledgement order message as the re-synchronization message to the MS 102, in case the MS 102 specifies in the rejection order message, the non-receipt of a null traffic message in response to receiving a channel assignment message from the communication infrastructure 104.

The MS 102 resumes the call setup after receiving the re-synchronization message. In an embodiment of the invention, resuming the call setup includes the MS 102 receiving a null traffic message from the communication infrastructure 104 and sending a traffic channel preamble by the MS 102 to the communication infrastructure 104. The traffic channel preamble is typically a sequence of all zero frames sent by the MS 102 as an aid to acquire the traffic channel.

In an embodiment of the invention, managing the call setup between the MS 102 and the communication infrastructure 104 includes receiving a call setup message at the communication infrastructure 104 from the MS 102, in order to initiate the call setup. An example of the call setup message includes, but is not limited to, an origination message. In this embodiment, managing the call setup also includes receiving a new ECAM message, which is a channel assignment message for the MS 102. This message is sent by the communication infrastructure 104 to assign a communication channel to the MS 102. The MS 102 receives the new ECAM message, if the MS 102 is unable to receive a prior ECAM message from the communication infrastructure 104, in response to sending the origination message. The re-synchronization message sent by the communication infrastructure 104 is dependent on the type of rejection order message sent by the MS 102. The cause of the call setup failure indicated in rejection order message is responsible for the corresponding change in the re-synchronization message. Hence appropriate synchronization is achieved.

FIG. 3 is an exemplary message flow diagram illustrating the messages exchanged between the MS 102 and the communication infrastructure 104 while managing a call setup in accordance with an embodiment of the invention. The MS 102 sends an origination message 302 to the communication infrastructure 104 to initiate a call setup. The communication infrastructure 104 sends a BS acknowledgement message 304 to the MS 102 in response to the receipt of the origination message 302. The BS acknowledgement message 304 is sent as an acknowledgement for the receipt of the origination message 302. The communication infrastructure 104 sends a first ECAM message 306 to the MS 102 within a pre-determined time period of sending the BS acknowledgement message. In an embodiment of the invention, the range of the pre-determined time period is typically between 80 and 500 milliseconds. The MS 102 detects non-receipt of the first ECAM message 306 as a call setup failure and sends an ECAM cause message 308 to the communication infrastructure 104. The non-receipt of the first ECAM message 306, at the MS 102, is detected when the pre-determined time period expires.

The ECAM cause message 308 is an embodiment of a rejection order message and indicates at least one cause from the one or more causes of the call setup failure to the communication infrastructure 104. The causes of the call setup failure include, but are not limited to, a high paging channel erasure rate, a given number of overhead messages lost, a high symbol error rate over an overhead or paging channel, low energy over the overhead or paging channel, a high number of idle handoffs, a last good call state of the MS 102, a next expected message, and a high number of idle handoffs over a time interval. In an embodiment of the invention, if the symbol error rate or the pilot signal strength received is low, then the MS 102 sends the ECAM cause message 308 with higher priority. This ensures that this particular cause of the call setup failure is not repeated. Also in case, the energy received over the overhead or paging channel is high then the MS sends the ECAM cause message 308 with higher priority. In accordance with the protocol applicable, the communication infrastructure 104 sends a set of extended channel assignment messages (ECAMs) 310 in response to the receipt of the ECAM cause message 308 and the cause characterized in the ECAM cause message 308. One of the ECAM message from the set of ECAMs 310 assigns a new traffic channel to the MS 102 to re-synchronize the call setup. The MS 102 resumes the call setup by acquiring a null traffic message 312 from the communication infrastructure 104 and sending a traffic channel preamble 314. In an embodiment of the invention, the null traffic message 312 is received within a first pre-determined time period of receiving one of the ECAMs from the set of ECAMs. In an example, the value of this first pre-determined time period ranges between 20 ms and 200 ms. In another embodiment of the invention, the traffic channel preamble 314 is sent within a second pre-determined time period of receiving an ECAM message. In an example, the value of this second pre-determined time period ranges between 100 ms and 800 ms. The sending of the TCH preamble 314 by the MS 102, and its subsequent receipt by the communication infrastructure 104, ensures that the call setup is successful.

In an embodiment of the invention, the communication infrastructure 104 sends a text message (not shown in FIG. 3), after sending the BS acknowledgement message 304, and prior to sending the first ECAM message 306. In an example, the communication infrastructure 104 sends the text message combined with the BS acknowledgement message 304, prior to sending the first ECAM message 306. In an embodiment of the invention, the text message can be a Short Message Service (SMS) message. In this embodiment, the MS 102 sends an SMS acknowledgement message in response to receiving the SMS message, which is combined with the BS acknowledgement message 304. In case the communication infrastructure 104 is unable to receive the SMS acknowledgement message it repeats the SMS message. If the MS 102 is unable to receive the SMS message, it detects non-receipt of the SMS message as a call setup failure. The MS 102 sends the ECAM cause message 308, indicating at least one cause of the call setup failure, instead of sending the SMS acknowledgement message. Hence delay in resuming the call setup is avoided. The communication infrastructure 104 repeats the SMS message in response to the receipt of the ECAM cause message 308.

In an embodiment of the invention, the communication infrastructure 104 indicates to the MS 102, in the BS acknowledgement message 304 or via overhead messaging, a time period or a criterion according to which the MS 102 should send an ECAM reception status report with paging channel frame erasure information. If the ECAM reception status report indicates the ECAM has not been received yet, and/or the paging channel frame erasure information indicates a highly loaded channel, the communication infrastructure 104 sends channel assignment messages with higher power and shorter time between message repetitions. In an embodiment of the invention, the MS 102 indicates a RF environment report (RER) to the communication infrastructure 104 in the origination message 302. The RER helps the communication infrastructure 104 to complete channel assignment.

In another embodiment of the invention, if the set of ECAM's 310 sent to the MS 102 are delayed, the MS 102 sends another rejection order message (not shown in FIG. 3) to the communication infrastructure 104. This rejection order message instructs the communication infrastructure 104 to send one or more ECAMs with increased power at repeated intervals to the MS 102. In an embodiment of the invention, if the communication infrastructure 104 receives the traffic channel preamble 314 while sending an ECAM, the communication infrastructure 104 stops sending the one or more ECAMs.

FIG. 4 is an exemplary message flow diagram illustrating the messages exchanged between the MS 102 and the communication infrastructure 104 in managing a call setup in accordance with another embodiment of the invention. The MS 102 sends the origination message 302 to the communication infrastructure 104 to initiate the call setup. The communication infrastructure 104 sends the BS acknowledgement message 304 to the MS 102 in response to receiving the receipt of the origination message 302. The BS acknowledgement message 304 is sent as an acknowledgement to the receipt of the origination message. The communication infrastructure 104 sends the first ECAM message 306 to the MS 102 within a pre-determined time period of sending the BS acknowledgement message 304. The first ECAM message 306 assigns a traffic channel to the MS 102. The communication infrastructure 104 sends the null traffic message 312 to the MS 102. The null traffic message 312 is a sequence of all zero frames, sent to maintain connectivity between the MS 102 and the communication infrastructure 104. The null traffic message 312 should be received within a pre-specified time period of receiving the first ECAM message 306. This pre-determined time period is dependent upon the protocol used for call setup. The pre-determined time period typically ranges between 20 ms and 200 ms.

In an embodiment of the invention, the null traffic message 312 may not be received by the MS 102 due to radio frequency (RF) related failures. In this embodiment, the MS 102 does not send the traffic channel preamble 314 to the communication infrastructure 104 within a pre-specified time period, since it does not receive the null traffic message 312. In an example, this pre-specified time period typically ranges between 100 ms and 800 ms. Since the communication infrastructure 104 does not receive the traffic channel preamble 314 within the pre-specified time period it assumes that a traffic channel is not assigned to the MS 102. Hence the communication infrastructure 104 and does not send the BS acknowledgement for the traffic channel preamble 402. The communication infrastructure 104 sends a second ECAM message 404 to the MS 102, to assign the traffic channel again. The MS 102 detects a call setup failure on receipt of the second ECAM message 404, and sends an MS rejection order message 406 to the communication infrastructure 104.

The MS rejection order message 406 indicates the cause of the call setup failure to the communication infrastructure 104. In an embodiment of the invention, the MS rejection order message 406 includes a first set of two bits, to indicate non-receipt of a next expected message by the MS 102 as the cause of the call setup failure. For example, the combination ‘00’ of the first set of two bits indicates non-receipt of the null traffic message 312, and the combination ‘01’ indicates non-receipt of the BS acknowledgement for the traffic channel preamble 402. Further, the combination ‘10’ of the first set of two bits indicates non-receipt of the first ECAM message 306, and the combination ‘00’ is not used. The communication infrastructure 104 sends a BS acknowledgement order message 408 to the MS 102, which is a re-synchronization message. In an embodiment, the BS acknowledgement order message 408 includes a second set of two bits. This second set of two bits instructs the MS 102 about the actions to be performed to resume the call setup. The combination ‘01’ of the second set of two bits indicates to the MS 102 that it should re-attempt traffic channel access by using a new RER. Whereas, the combination ‘10’ indicates to the MS 102 that it should retry the call setup with a new ECAM sent by the communication infrastructure 104. The combination ‘11’ of the second set of two bits indicates to the MS 102 that it should retry the call setup with the first ECAM message 306 sent, while the combination ‘00’ is not used. In the case of the combination ‘10’, the communication infrastructure 104 sends a new ECAM message 410 to the MS 102 to assign a new traffic channel to the MS 102, to resume the call setup. The MS 102 resumes the call setup by again acquiring the null traffic message 312 from the communication infrastructure 104. Thereafter, the MS 102 again sends the traffic channel preamble 314 in response to the null traffic message 312 indicating that the MS 102 has acquired the traffic channel. The sending of the TCH preamble 314 by the MS 102, and its subsequent receipt by the communication infrastructure 104, ensures that the call setup is successful.

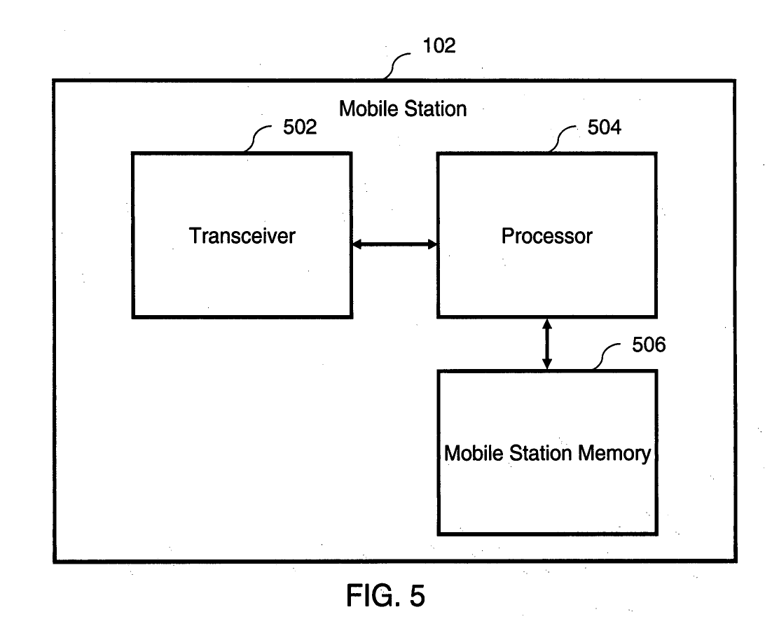

FIG. 5 represents a block diagram of the MS 102, in accordance with an embodiment of the invention. The MS 102 includes a transceiver 502, a processor 504 and an MS memory 506. The transceiver 502 receives and transmits communication messages regarding setting up a communication channel for communication between the MS 102 and the communication infrastructure 104. Examples of the communication messages include, but are not limited to, the origination message, the channel assignment message, the rejection order message, and the re-synchronization message. The processor 504 is coupled to the transceiver 502, has access to the communication messages, and keeps a record of the timing of the communication messages. The processor 504 detects a call setup failure, based on non-receipt of one or more communication messages within a set of pre-specified time periods. The processor 504 instructs the transceiver 502 to send the rejection order message to the communication infrastructure 104, to indicate at least one cause of the call setup failure. The causes of the call setup failure include, but are not limited to, a high paging channel erasure rate, the number of overhead messages lost, a high symbol error rate over an overhead or paging channel, low energy over the overhead or paging channel, a high number of idle handoffs, the last good call state of the MS 102, a next expected message, and a high number of idle handoffs over a time interval. Examples of the next expected message include, but are not limited to, the first ECAM message 306, the null traffic message 312, and the BS acknowledgement message for TCH preamble 402. The processor 504 is coupled to the MS memory 506 where the MS memory 506 stores an call state of the MS 102 after there is an exchange of a message with the communication infrastructure 104. The MS 102 has an independent call state machine that changes its state based on the messages the MS 102 exchanges with the communication infrastructure 104. Non-receipt of any expected message leads to un-synchronization of the call state machine of the MS 102. In other words, the MS memory 506 records every message sent or received by the MS 102. In an embodiment of the invention, the MS memory 506 stores the last good call state of the MS 102. This helps the communication infrastructure 104 to send appropriate messages to restore the MS 102 back to the last good call state instead of restarting the entire call state machine of MS 102.

The processor 504 receives a re-synchronization message from the communication infrastructure 104 to re-synchronize the call setup. In an embodiment of the invention, the processor 504 also instructs the transceiver 502 to send messages for the resumption of the call setup, in response to the receipt of the rejection order message. In another embodiment of the invention, the MS 102 receives the call setup message from the communication infrastructure 104, for the initiation of the call setup. In yet another embodiment of the invention, the MS 102 receives at least one of the set of channel assignment messages and the acknowledgement order message from the communication infrastructure 104. In still another embodiment of the invention, the MS 102 establishes the communication channel according to the received re-synchronization message.

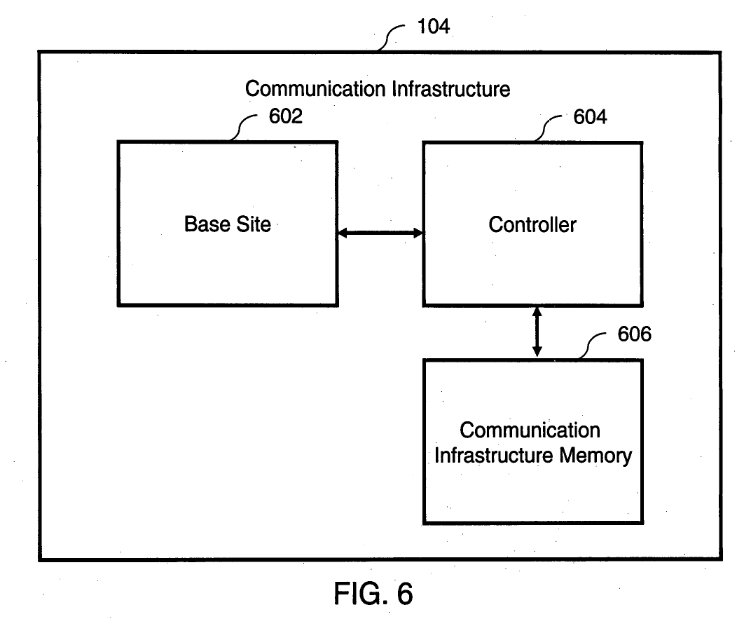

FIG. 6 represents a block diagram of the communication infrastructure 104, in accordance with an embodiment of the invention. The communication infrastructure 104 includes a base site 602, a controller 604 and a communication infrastructure memory 606. The base site 602 receives and transmits the communication messages regarding establishing a communication channel for communication between the MS 102 and the communication infrastructure 104. In an embodiment the base site 602 detects a call setup failure based on the rejection order message. The controller 604 is coupled to the base site 602. The controller 604 instructs the base site 602 to send a re-synchronization message to the MS 102 in response to the rejection order message received from the MS 102. The communication infrastructure memory 606 stores a call state of the communication infrastructure 104 after there is an exchange of a message with the MS 102. The communication infrastructure 104 also has an independent call state machine that changes its state based on the messages it exchanges with the MS 102. Non-receipt of any expected message leads to un-synchronization of the call state machine of the communication infrastructure 104. In an embodiment of the invention, the communication infrastructure memory 606 stores the last good call state of the communication infrastructure 104. This helps the communication infrastructure 104 to send appropriate re-synchronization message for the MS 102 so that it can be restored back to the last good call state instead of restarting the entire call state machines of both the MS 102 and the communication infrastructure 104. In another embodiment, the communication infrastructure 104 may either propose a next call state to the MS 102 to resume the call setup. In yet another embodiment, the communication infrastructure 104 may restart the call state machine of the MS 102. In still another embodiment, the communication infrastructure 104 may configure the MS to either include or exclude its current system. [Query to the inventors: Please provide details on current system of the MS.]

In an embodiment of the invention, the re-synchronization message is the BS acknowledgement order message 408. The re-synchronization message is sent, based on one cause of the one or more causes of the call setup failure in the rejection order message. The causes of the call setup failure include, but are not limited to, a high paging channel erasure rate, the number of overhead messages lost, a high symbol error rate over an overhead or paging channel, low energy over the overhead or paging channel, a high number of idle handoffs, the last good call state of the MS 102, the next expected message, and a high number of idle handoffs over a time interval. Examples of the next expected message include, but are not limited to, the first ECAM message 306, the null traffic message 312, and the BS acknowledgement message 402 for the TCH preamble 402. Examples of the re-synchronization message include, but are not limited to, the set of ECAMs 310 and the BS acknowledgement order message 408. The controller 604 has access to the communication messages and keeps a record of the timing of the communication messages. In an embodiment of the invention, the controller 604 further instructs the base site 602 to send a call setup message to the MS 102, in order to initiate the call setup. In another embodiment of the invention, the controller 604 associates with the base site 602 to send at least one of the set of channel assignment messages and the acknowledgement order message. The controller 604 also associates with the base site 602 and establishes the communication channel after sending the re-synchronization message.

As described above, the present invention solves the problems of resynchronization between a mobile station and a communication infrastructure after a call setup failure by providing a method for the detection of the call setup failure by the mobile station and sending re-synchronization messages from the communication infrastructure to the mobile station. This re-synchronization avoids the delays involved in resuming a call setup after the call setup failure. Further, the mobile station resumes the call setup without any user intervention. The faster call setup also improves the page response and reduces call failures and call drops. This results in increased access channel and paging channel capacity and efficient use of channel resources in all CDMA based wireless systems like IS-95, IS-2000, W-CDMA and any future CDMA based technologies. The faster call setup time also enhances the Push-to-talk user experience in CDMA based Push-to-talk systems. The present invention provides a call resume mechanism after a call setup failure, which provides a uniform operation for various service providers. Various embodiments of the present invention also provide methods for synchronizing any two call state machines, with minimum delay involved in restoring the call setup. In this call resume mechanism the call state machines of the interacting elements are restored from the point they were un-synchronized instead of restarting the entire call state machines. Further, the present invention can be used with various second and third generation technologies such as Evolution Data Voice (EVDV), Universal Mobile Telecommunications System (UMTS), and High-Speed Downlink Packet Access (HSDPA). It also enables full backward compatibility and deployability with all CDMA based technologies.

It will be appreciated that embodiments of the invention described herein may be comprised of one or more conventional processors and unique stored program instructions that control the one or more processors to implement, in conjunction with certain non-processor circuits, some, most, or all of the functions of communication between mobile stations described herein. The non-processor circuits may include, but are not limited to, a radio receiver, a radio transmitter, signal drivers, clock circuits, power source circuits, and user input devices. As such, these functions may be interpreted as steps of a method to perform communication between mobile stations. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of managing a call setup between a mobile station and a communication infrastructure comprising:
detecting a call setup failure;
sending a rejection order message wherein the rejection order message states at least one cause of the call setup failure; and
re-synchronizing the call setup by responding with a re-synchronization message in response to the rejection order message.

2. The method of claim 1 further comprising receiving a call setup message.

3. The method of claim 1 further comprising resuming the call setup in response to the re-synchronizing.

4. The method of claim 1 wherein detecting the call setup failure and sending the rejection order message is being performed by the mobile station.

5. The method of claim 1 wherein the at least one cause included in the rejection order message is selected from a group comprising:
a number overhead messages lost;
symbol error rate perceived over an overhead or paging channel;
energy received over the overhead or paging channel;
last good call state of the mobile station;
a next expected message;
a time since a last idle handoff; and
a number of idle handoffs over a time interval.

6. The method of claim 1 wherein re-synchronizing the call setup is being performed by the communication infrastructure.

7. The method of claim 1 wherein detecting the call setup failure is being performed by the communication infrastructure.

8. The method of claim 7 further comprises performing at least one of proposing a next call state, restart of call state machine and configuration of the mobile station to exclude current system.

9. The method of claim 1 wherein the re-synchronizing comprising sending at least one of a set of channel assignment messages and an acknowledgement order message from the communication infrastructure.

10. The method of claim 9, wherein sending the at least one of a set of channel assignment messages includes sending the set of channel assignment messages with higher power and shorter time between message repetitions in response to having received the rejection order message.

11. A mobile station comprising:
a transceiver being arranged to receive and transmit messages regarding setting up a communication channel; and
a processor coupled to the transceiver to detect a call setup failure and to instruct the transceiver to transmit a rejection order message wherein the rejection order message indicates at least one cause of the call setup failure, wherein the processor is further arranged to receive a re-synchronization message to resynchronize call setup in response to the at least one cause of the call setup failure.

12. The mobile station of claim 11 wherein the processor further resumes the call setup in response to the re-synchronizing message.

13. The mobile station of claim 11 wherein the at least one cause included in the rejection order message is selected from a group comprising:
a number overhead messages lost;
symbol error rate perceived over an overhead or paging channel;
energy received over the overhead or paging channel;
last good call state of the mobile station;
a next expected message;
a time since a last idle handoff; and
a number of idle handoffs over a time interval.

14. The mobile station of claim 13 further comprises a memory to store the last good call state of the mobile station.

15. The mobile station of claim 11 wherein the processor further receives a call setup message.

16. The mobile station of claim 11 wherein the processor further arranged with the transceiver to receive at least one of a set of channel assignment messages and an acknowledgement order message from a communication infrastructure.

17. The mobile station of claim 11 wherein the processor further arranged with the transceiver to establish a communication channel in response to the re-synchronization message.

18. A communication infrastructure comprising:
a base site arranged to transmit and receive messages to establish a communication channel; and
a controller, coupled to the base site, arranged to instruct the base site to send a re-synchronization message in response to a rejection order message, wherein the rejection order message indicates at least one cause of the call setup failure, wherein the re-synchronization message utilizes the at least one cause of the call setup failure to establish the communication channel.

19. The communication infrastructure of claim 18 wherein the at least one cause included in the rejection order message is selected from a group comprising:
a number overhead messages lost;
symbol error rate perceived over an overhead or paging channel;
energy received over the overhead or paging channel;
last good call state of the communication infrastructure;
a next expected message;
a time since a last idle handoff; and
a number of idle handoffs over a time interval.

20. The communication infrastructure of claim 19 further comprises a memory to store the last good call state of the communication infrastructure.

21. The communication infrastructure of claim 18 wherein the controller further arranged for the base site to send a call setup message.

22. The communication infrastructure of claim 18 wherein the controller further arranged with the base site to resend at least one of a set of channel assignment messages and an acknowledgement order message.

23. The communication infrastructure of claim 18 wherein the controller further arranged with the base site to establish the communication channel in response to the re-synchronization message.
